(19) United States
(12) Patent Application Publication
(10) Pub. No.: US 2025/0129982 A1
(43) Pub. Date: Apr. 24, 2025

(54) VENT MODULE

(71) Applicant: HYUNDAI MOBIS CO., LTD., Seoul (KR)

(72) Inventor: Ik Keun CHOI, Yongin-si (KR)

(73) Assignee: HYUNDAI MOBIS CO., LTD., Seoul (KR)

(21) Appl. No.: 18/733,024

(22) Filed: Jun. 4, 2024

(30) Foreign Application Priority Data
Oct. 24, 2023 (KR) 10-2023-0142842

(51) Int. Cl. F25D 23/02; F25D 17/06

(52) U.S. Cl. CPC F25D 23/028; F25D 17/06; F25D 2323/024

(57) ABSTRACT

A vent module according to one embodiment of the present invention may include a housing having an open upper side and having a communication hole formed on a rear side of the housing and through which air flows, a housing door rotatably connected to the housing to open or close the open upper side of the housing, and a vent portion that is inserted through the communication hole and rotatably mounted inside the housing and discharges air, and the vent portion may adjust an air discharge direction by being exposed to an upper side of the housing depending on a rotation angle of the vent portion.

### CROSS-REFERENCE TO RELATED APPLICATION

This application claims priority to and the benefit of Korean Patent Application No. 10-2023-0142842, filed on Oct. 24, 2023, the disclosure of which is incorporated herein by reference in its entirety.

### BACKGROUND

### 1. Field of the Invention

The present invention relates to a vent module, and more specifically, to a vent module capable of implementing a hidden design and refrigerating a tray when not in use.

### 2. Discussion of Related Art

A plurality of vents are provided in a cockpit module for cooling, heating and ventilation inside a vehicle. In general, vents disposed at the front of the vehicle consist of two center parts and two side parts.

As the types and functions of vehicles become more diverse, purpose-built vehicles (PBVs) are also being developed. The PBV is a vehicle for achieving a specific purpose, and may include a PBV dedicated to last mile transportation and delivery, a PBV for transporting semiconductors, or the like.

For the PBV, autonomous driving may be applied, and a structure of the vehicle is also different from the existing one as there may be no passengers or only one driver. Therefore, it is necessary to develop a cockpit for one driver, but it is highly likely that, instead of using four vents in the related art, only two in the center part and one in the side part (a driver's seat) will be applied. In this case, there may be difficulties in air conditioning inside the vehicle and a separate vent may be required. For the vehicle design and characteristics of the PBV, vents for which a hidden design may be implemented and which have multiple functions are being studied.

### SUMMARY OF THE INVENTION

One embodiment of the present invention is directed to providing a vent module capable of facilitating air conditioning inside a vehicle, and implementing a hidden design and at the same time, having multiple functions.

Problems to be solved by the present invention are not limited to those mentioned above, and other problems not mentioned will be clearly understood by those skilled in the art from the following description.

According to an aspect of the present invention, there is provided a vent module including a housing having an open upper side and having a communication hole formed on a rear side of the housing and through which air flows, a housing door rotatably connected to the housing to open or close an open side of the housing, and a vent portion that is inserted through the communication hole and rotatably mounted inside the housing and discharges air.

The vent portion may adjust an air discharge direction by being exposed to an upper side of the housing depending on a rotation angle of the vent portion.

A hinge of the vent portion may be formed at a rear side of the vent portion in a direction parallel to a width direction of the housing.

The vent portion may be disposed in a first position where the vent portion is inserted into the housing in response to being rotated downward at a maximum angle and a second position where the vent portion is exposed to the open upper side of the housing in response to being rotated upward at a maximum angle.

When the vent portion is disposed in the first position, air may flow inside the housing, and when the vent portion is disposed in the second position, air may flow inside a vehicle.

The vent portion may include a cover disposed in a horizontal direction when the vent portion is disposed in the first position, an inflow portion that is formed at one end of the cover in a direction intersecting a surface direction of the cover and through which air flows in, and a discharge portion which connects the cover and the inflow portion and through which air is discharged.

The inflow portion may be disposed in a horizontal direction when the vent portion is disposed in the second position.

A hose serving as a passage through which air flows in may be connected to the inflow portion of the vent portion.

A rib for guiding the air discharge direction may be formed in the discharge portion, and the rib may be formed to be inclined in a surface direction of the discharge portion.

A hinge may be formed at one end where the cover and the inflow portion are connected, and fixing pins that are caught on and fixed to an upper portion of the housing may be formed at the other ends of the cover and the inflow portion.

The fixing pin formed on the cover may be caught on the housing when the vent portion is disposed in the first position, and the fixing pin formed on the inflow portion may be caught on the housing when the vent portion is disposed in the second position.

A fastener for fixing the housing door in a closed state may be formed on one side of the housing door, and the fastener may protrude by receiving an elastic force from an elastic body and may be caught on a fastening groove formed in the housing.

The discharge portion may be formed to be curved so that the vent portion is formed in a fan shape, and the vent portion may rotate based on the center of a circle forming the fan shape.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view showing a cockpit to which a vent module according to one embodiment of the present invention is applied;

FIG. 2 is a perspective view of the vent module according to one embodiment of the present invention;

FIG. 3 is a cross-sectional view of the vent module according to one embodiment of the present invention disposed in a first position;

FIG. 4 is a cross-sectional view of the vent module according to one embodiment of the present invention disposed in a second position;

FIG. 5 is a view showing a vent portion of the vent module according to one embodiment of the present invention disposed in a first position;

FIG. 6 is a view showing the vent portion of the vent module according to one embodiment of the present invention disposed in a second position;

FIG. 7 is a view showing a housing door of a vent module according to another embodiment of the present invention;

FIG. 8 is a view showing a cross section of the housing door of the vent module according to another embodiment of the present invention;

FIG. 9 is a view showing a vent portion of a vent module according to still another embodiment of the present invention; and

FIG. 10 is a view showing a vent module according to yet another embodiment of the present invention.

### DETAILED DESCRIPTION OF EXEMPLARY EMBODIMENTS

Since the present invention may be variously modified and embodied, particular embodiments thereof will be illustrated in the drawings and described in detail. However, this is not intended to limit the present invention to the specific embodiments, and it should be understood to include all modifications, equivalents, and substitutes included in the spirit and scope of the present invention. In describing the present invention, when it is determined that the detailed description of the related known technology may obscure the subject matter of the present invention, the detailed description thereof will be omitted.

Terms “first,” “second,” etc., may be used herein to describe various elements, but the elements should not be limited by the terms. These terms are only used to distinguish one element from another element.

The terms used in the present application are merely provided to describe specific embodiments, and are not intended to limit the present invention. The singular forms are intended to include the plural forms as well, unless the context clearly indicates otherwise. In the present application, it will be understood that terms “include,” “have,” or the like are intended to specify the presence of features, integers, steps, operations, elements, components, and/or combinations thereof stated in the specification, but do not preclude the possibility of the presence or addition of one or more other features, integers, steps, operations, elements, components, or combinations thereof in advance.

In addition, throughout the specification, when “connected” is used, this does not only mean two or more components are directly connected, but means that two or more components are indirectly connected through another component, that the components are not only physically connected, but also electrically connected, or that the components are integrated although the components are referred to as different names depending on a location or a function.

Further, when a component is described as being formed or disposed “on (above) or under (below)” of another component, the term “on (above) or under (below)” includes not only when two components are in direct contact with each other, but also when one or more of other components are formed or disposed between the two components. Further, when a component is described as being “on (above) or below (under),” the description may include the meanings of an upward direction and a downward direction based on one component.

Hereinafter, one embodiment of a vent module according to the present invention will be described in detail with reference to the accompanying drawings, and identical or corresponding components will be assigned the same numbers and overlapping descriptions thereof will be omitted.

Models that are one level of improvement over existing vehicles, such as autonomous driving vehicle, electric vehicles, or the like, are continuously being developed. Furthermore, in recent years, purpose-built vehicles in which the interior and exterior of the vehicles are modified to support functions suited to purposes of the vehicles have been developed. A purpose-built vehicle is a vehicle whose purpose is not simply to transport occupants, but rather to provide a vehicle suitable for achieving a purpose desired by a user, such as transporting goods or camping by configuring the vehicle according to the purpose.

For the purpose-built vehicle, in general, the seating arrangement inside the vehicle is different from that of existing vehicles, and a cockpit module 1 formed at the front of a driver's seat may also be formed in a reduced form for a single driver's seat. However, when an existing air conditioning device is applied to the reduced cockpit module 1, there may be difficulties in air conditioning inside the vehicle.

The existing air conditioning system achieved air conditioning inside the vehicle by utilizing a total of four vents, two in the center part of the vehicle and two in the side part, but for the reduced cockpit module 1, two vents in the center part and one vent in a driver's side part may be utilized, making it difficult to control the temperature of the air inside the vehicle.

In order to solve the aforementioned problem, a vent module 100 that is installed on one side of the cockpit module 1 to condition the air inside the vehicle and has a separate function is required. The present invention provides the vent module 100 capable of, through a housing 10 connected to the cockpit module 1 and a vent portion 20 inserted into the housing 10, implementing a hidden design and at the same time conditioning the air inside the vehicle, and achieving a refrigeration function by cooling the inside of the housing 10.

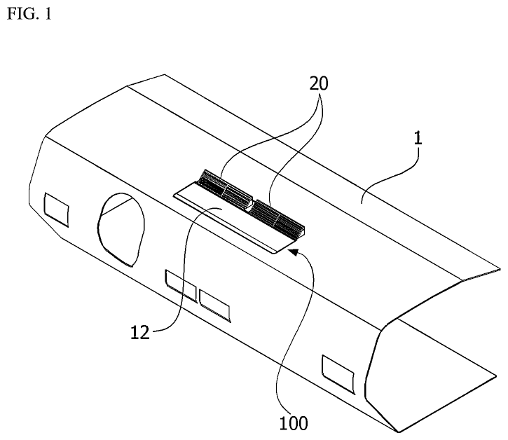

FIG. 1 is a view showing a cockpit to which a vent module according to one embodiment of the present invention is applied.

Referring to FIG. 1, a vent module 100 may be connected to an upper side of a cockpit module 1 of a vehicle, and may discharge air into the inside of the vehicle so that cooling and heating are possible. A housing 10 and a housing door 12 may be formed at the front of a vent portion 20 so that an occupant stores drinks, food, or separate luggage inside the housing 10.

There is no limit to a position where the vent module 100 is installed, and the position may be changed to facilitate adjusting the air temperature inside the vehicle depending on the position of the vent applied to the vehicle.

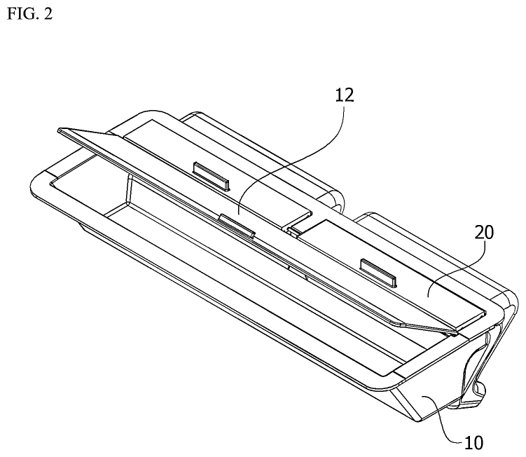

FIG. 2 is a perspective view of the vent module according to one embodiment of the present invention.

Referring to FIG. 2, the vent module 100 according to one embodiment of the present invention may include the housing 10 having an open upper side and having a communication hole 14 through which air flows in formed on a rear side, the housing door 12 rotatably connected to the housing 10 to open or close the open upper side of the housing 10, and the vent portion 20 that is rotatably disposed inside the housing 10 by being inserted through the communication hole 14 and discharges air.

The vent portion 20 may be disposed at the rear side of the housing door 12, and a plurality of vent portions 20 may be formed. FIG. 2 shows that two vent portions 20 are formed at the rear side of the housing door 12. The housing door 12 may be opened and closed in a rotating manner, and a rotation axis may be formed at a rear border of the housing door 12 to facilitate opening and closing the housing door 12.

Similarly, a rotation axis of the vent portion 20 may also be formed at the rear side of the vent portion 20 to facilitate rotation of the vent portion 20. The rotation axes of the vent portion 20 and the housing door 12 may be formed to extend in a width direction of the housing 10.

The housing 10 may be connected to the upper side of the cockpit module 1 for easy access by the occupant, and the occupant may open the housing door 12 and store luggage inside the housing 10. In addition, since the vent portion 20 may discharge air into the housing 10, refrigeration inside the housing 10 may also be possible. Therefore, the occupant may store drinks, food, or the like that require refrigeration inside the housing 10.

The plurality of vent portions 20 may be individually controlled, and thus at least some of the vent portions may be arranged to discharge air into the housing 10, and the remaining vent portions may be rotated to discharge air into the vehicle.

A handle may be formed on one end of the vent portion 20 and the housing door 12 so that the user rotates the vent portion and the housing door by pulling the handle. The user may open or close the housing door 12 in a way of holding the handle and lifting the handle upward to adjust the vent portion 20 to be inserted into the housing 10 or to be exposed to the open upper side of the housing 10 so that air is discharged into the vehicle.

Alternatively, the vent portion 20 and the housing door 12 may be electronically rotated. Motors may be mounted on rotation axes of the vent portion 20 and the housing door 12, and when the user operates a button, a controller may drive the motors to rotate the vent portion 20 and the housing door 12 by a preset value.

Hereinafter, a position where the vent portion 20 is inserted into the housing 10 in response to being rotated downward at a maximum angle is referred to as a first position, and a position where the vent portion 20 is exposed outside the housing 10 in response to being rotated upward at a maximum angle so that air is discharged into the vehicle is referred to as a second position.

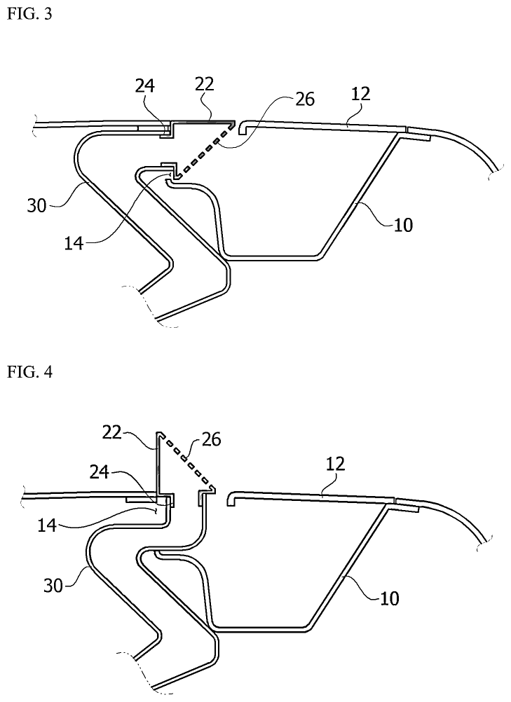

FIG. 3 is a cross-sectional view of the vent module according to one embodiment of the present invention disposed in the first position, and FIG. 4 is a cross-sectional view of the vent module according to one embodiment of the present invention disposed in the second position.

Referring to FIGS. 3 and 4, the vent portion 20 of the vent module 100 according to one embodiment of the present invention may include a cover 22 disposed in a horizontal direction when the vent portion is disposed in the first position, an inflow portion 24 that is formed at one end of the cover 22 in a direction intersecting a surface direction of the cover 22 and through which air flows in, and a discharge portion 26 that connects the cover 22 and the inflow portion 24 and through which air is discharged.

As shown in the drawing, a cross section of the vent portion 20 including the cover 22, the inflow portion 24, and the discharge portion 26 may be triangular, and the cover 22 and the inflow portion 24 may be formed to vertically intersect. The arrangement of the cover 22 and the inflow portion 24 does not matter even if they are not vertical, and any arrangement may be used as long as the vent portion 20 may be fully inserted into the housing 10 or fully exposed depending on the rotation angle of the vent portion 20.

The vent portion 20 may have three surfaces formed by the cover 22, the inflow portion 24, and the discharge portion 26, and both side surfaces thereof may also be formed to be closed so that air is discharged only through the discharge portion 26. The discharge portion 26 may be opened with a hole formed so that air may be discharged.

A communication hole 14 may be formed at the rear side of the housing 10. The vent portion 20 may be disposed inside the housing 10 by being inserted through the communication hole 14. The rear side of the housing 10 may be formed to extend so that the vent portion 20 is inserted and disposed, and the communication hole 14 may be formed at a rear end of the extended portion. An upper side of the extended portion may be formed to be open so that the vent portion 20 is exposed to the open upper side of the housing 10 by rotating, and the opened surface may be formed to be connected to a surface covered by the housing door 12. That is, the upper side of the housing 10 may be formed to be entirely open, but at least a part thereof may be opened and closed by the housing door 12, and the remaining part may be opened and closed by the vent portion 20.

A hose 30 may be connected to the inflow portion 24 of the vent portion 20. The hose 30 may serve as a duct connecting an air outlet of an air conditioning device and the vent portion 20, and the hose 30 may be formed to be movable or deformable. That is, the hose 30 may be made of a material whose shape is freely deformable, such as rubber to be moved or changed in shape in response to the rotation of the vent portion 20.

When the vent portion 20 is disposed in the second position by rotating as shown in the drawing, the hose 30 may be disposed by being inserted into the housing 10 through the communication hole 14 according to the position of the inflow portion 24 of the vent portion 20.

Referring to FIG. 3, when the vent portion 20 is disposed in the first position, the cover 22 may be disposed in a horizontal direction so that the vent portion 20 is not exposed to the outside of the housing 10, and thus may be disposed on the same plane as the housing door 12 closing the open upper side of the housing 10. In this way, a hidden design of the vent module 100 may be implemented. Since the discharge portion 26 of the vent portion 20 disposed in the first position is directed toward the inside of the housing 10, cooled and heated air may be discharged into the housing 10, and the temperature of the inside of the housing 10 may be adjusted.

Referring to FIG. 4, the vent portion 20 may be exposed to the open upper side of the housing 10 when disposed in the second position. The vent portion 20 may be rotated using a point where the cover 22 and the inflow portion 24 come into contact as a rotation axis, the inflow portion 24 may be disposed in the horizontal direction to be disposed on the same plane as the housing door 12 closing the open surface of the housing 10, and the vent portion 20 may be exposed to the outside of the housing 10.

Since the discharge portion 26 of the vent portion 20 disposed in the second position is directed toward the inside of the vehicle and the inflow portion 24 is rotated and moved to the upper side of the housing 10, the hose 30 connected to the inflow portion 24 may also be correspondingly inserted and moved to the inside of the housing 10 and allow air to flow in through the inflow portion 24 so that the air is discharged to the discharge portion 26.

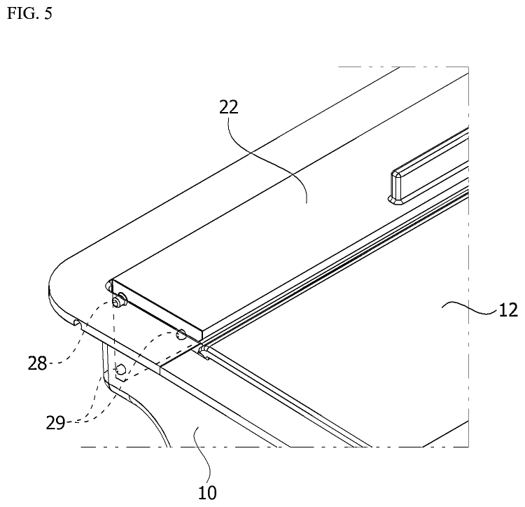

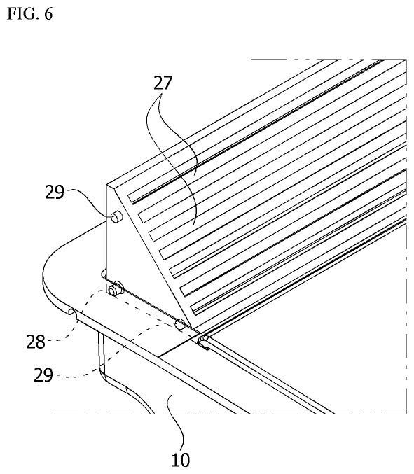

FIG. 5 is a view showing the vent portion of the vent module according to one embodiment of the present invention disposed in the first position, and FIG. 6 is a view showing the vent portion of the vent module according to one embodiment of the present invention disposed in the second position.

Referring to FIGS. 5 and 6, fixing pins 29 may be formed on both side surfaces of the vent portion 20. Since the vent portion 20 is rotatable inside the housing 10, the vent portion 20 needs to be maintained in a fixed state in the first position and the second position. The fixing pins 29 may protrude from both side surfaces of the vent portion 20, and the fixing pins 29 may fix the vent portion 20 by being caught in grooves formed on an inner surface of the housing 10.

The fixing pin 29 and the hinge 28 may be disposed near respective vertices of a triangle, which is a cross-sectional shape of the vent portion 20, and may fix the vent portion 20 to correspond to the first position and the second position. When the vent portion 20 is disposed in the first position as shown in FIG. 5, the fixing pin 29 formed at the vertex formed by the cover 22 and the discharge portion 26 may maintain a state of being disposed in the first position by being caught on the housing 10. In this case, the cover 22 may be disposed in the horizontal direction, and thus the vent portion 20 may not be exposed to the open upper side of the housing 10.

When the vent portion 20 is disposed in the second position as shown in FIG. 6, the fixing pin 29 formed at the vertex formed by the inflow portion 24 and the discharge portion 26 may be caught on the housing 10. The vent portion 20 may maintain a state of being disposed in the second position. In this case, since the inflow portion 24 may be disposed in the horizontal direction, the vent portion 20 may be fully exposed to the open upper side of the housing 10, and the discharge portion 26 is opened toward the inside of the vehicle, the air temperature inside the vehicle may be controlled.

Referring to FIG. 6, ribs 27 for guiding the air direction may be formed in the discharge portion 26. Since the discharge portion 26 is formed to be open, the discharge portion 26 may be formed to be entirely open except for an edge without the ribs 27. Alternatively, when it is desired to provide indirect wind to a passenger, a mesh-shaped cover may be disposed on the open side of the discharge portion 26 to implement the indirect wind.

Alternatively, as shown in the drawing, the ribs 27 may be formed to discharge air in a direction perpendicular to the open side of the discharge portion 26. The ribs 27 may be formed parallel to each other, and may also be formed to spread in a radial direction with respect to the hinge 28 of the vent portion 20.

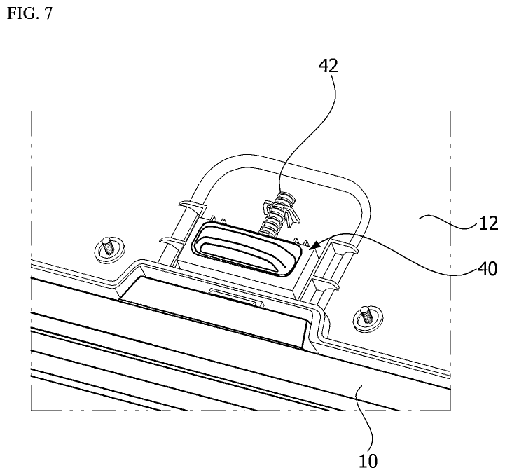

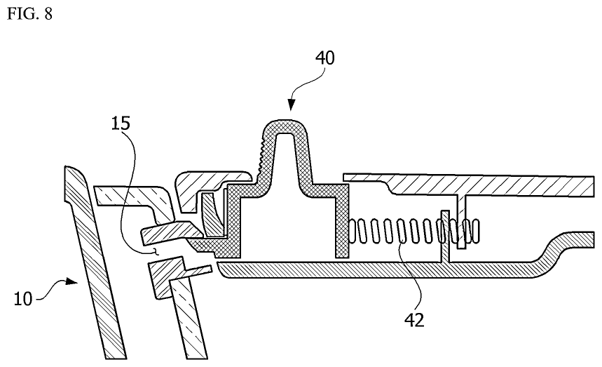

FIG. 7 is a view showing a housing door of a vent module according to another embodiment of the present invention, and FIG. 8 is a view showing a cross section of the housing door of the vent module according to another embodiment of the present invention.

A housing door 12 opens and closes an open side of a housing 10, but needs to maintain a state of being fixed while closing. This is because when a vehicle body shakes due to the movement of a vehicle, there is a risk that the items stored inside the housing 10 may be separated to the outside of the housing 10.

Referring to FIGS. 7 and 8, a fastener 40 for fixing the housing door 12 in a closed state may be formed on one side of the housing door 12. The fastener 40 may protrude by receiving an elastic force from an elastic body 42 disposed on one side of the fastener 40, and the housing door 12 may be fixed in a way that the fastener 40 protrudes and is caught on a fastening groove 15 formed in the housing 10.

When a user opens the housing door 12 to open the housing 10, the user may push the fastener 40 in a direction opposite to the elastic force provided by the elastic body 42 so that the fastener 40 is separated from the fastening groove 15, and then lift the fastener 40 upward to open the housing door 12. The elastic body 42 may be a spring, and is not limited as long as the elastic body 42 provides the elastic force to the fastener 40 so that the fastener 40 is inserted into the fastening groove 15.

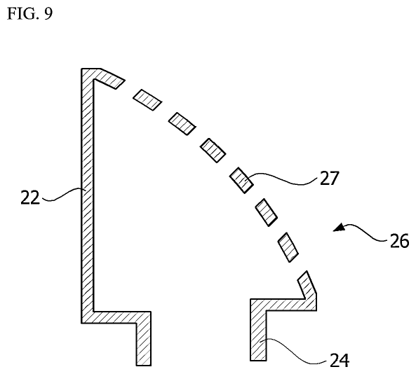

FIG. 9 is a view showing a vent portion of a vent module according to still another embodiment of the present invention.

Referring to FIG. 9, in a vent portion 20 of a vent module 100 according to still another embodiment of the present invention, a discharge portion 26 may be formed to be curved. Since the discharge portion 26 is a part for discharging air, the discharge portion 26 may be formed to have a curvature so that the air is spread out over a wide range.

In the vent portion 20, since the discharge portion 26 connects an inflow portion 24 and a cover 22, the discharge portion 26 may be curved to form a fan shape. When the vent portion 20 is formed in the fan shape, air may be discharged as if the air spreads out in a radial direction in the fan shape. In order to widen a discharge direction of air, ribs 27 may be formed in the discharge portion 26 in the radial direction.

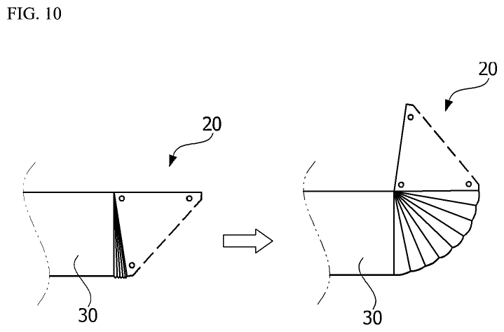

FIG. 10 is a view showing a vent module according to yet another embodiment of the present invention.

Referring to FIG. 10, a hose 30 connected to an inflow portion 24 of a vent portion 20 may be formed to be folded when the vent portion 20 is disposed in a first position, and to be unfolded correspondingly when the vent portion 20 is disposed in a second position. The hose 30 may be made of a material such as rubber, and a wrinkle may be formed at an end connected to the inflow portion 24 of the hose 30 so that the hose 30 is folded in a direction of the wrinkle.

The vent portion 20 in FIG. 10 is shown to have a shape of an acute triangle rather than a right triangle. That is, an angle at which the cover 22 and the inflow portion 24 intersect may not be vertical but may be less than 90 degrees. In this case, an angle at which the vent portion 20 is rotated may be reduced. Alternatively, the angle at which the cover 22 and the inflow portion 24 intersect may be formed to be greater than 90 degrees, and in this case, the angle at which the vent portion 20 is needed be rotated in order to be exposed to the open upper side of the housing 10 may become even larger correspondingly.

According to one embodiment of the present invention, it is possible to facilitate air conditioning inside a vehicle through a vent portion rotatably disposed inside a housing and at the same time, to implement a hidden design by inserting the vent portion inside the housing, and it is possible to have functions other than vehicle air conditioning by allowing cooling of the inside of the housing.

Various beneficial advantages and effects of the present invention are not limited by the contents described above and should be easily understood through a description of a detailed embodiment of the present invention.

Although the specific embodiments of the present invention have been described above, it is understood that one ordinary skilled in the art can make various changes and modifications to the present invention without departing from the spirit and scope of the present invention as hereinafter claimed.

What is claimed is:

1. A vent module comprising:
a housing having an open upper side and including a communication hole formed on a rear side of the housing and through which air flows;
a housing door rotatably connected to the housing to open or close the open upper side of the housing; and
a vent portion that is inserted through the communication hole and rotatably mounted inside the housing and discharges air,
wherein the vent portion adjusts an air discharge direction in response to being exposed to an upper side of the housing through the open upper side, depending on a rotation angle of the vent portion.

2. The vent module of claim 1, wherein a hinge of the vent portion is formed at a rear side of the vent portion in a direction parallel to a width direction of the housing.

3. The vent module of claim 2, wherein the vent portion is disposed in:
a first position where the vent portion is inserted into the housing in response to being rotated downward at a maximum angle; and
a second position where the vent portion is exposed to the open upper side of the housing in response to being rotated upward at a maximum angle, and in response that the vent portion is disposed in the first position, air flows inside the housing through the vent portion, and in response that the vent portion is disposed in the second position, air flows inside a vehicle through the vent portion.

4. The vent module of claim 3,
wherein the vent portion includes:
a cover disposed in a horizontal direction in a state that the vent portion is disposed in the first position;
an inflow portion that is formed at one end of the cover in a direction intersecting a surface direction of the cover and through which air flows in; and
a discharge portion that connects the cover and the inflow portion and through which air is discharged, and wherein the inflow portion is disposed in the horizontal direction in a state that the vent portion is disposed in the second position.

5. The vent module of claim 4, wherein a hose serving as a passage through which air flows in is mounted in the communication hole and connected to the inflow portion of the vent portion.

6. The vent module of claim 5, wherein a rib for guiding the air discharge direction is formed in the discharge portion.

7. The vent module of claim 6, wherein the rib is formed to be inclined in a surface direction of the discharge portion.

8. The vent module of claim 5, wherein the hinge is formed at one end where the cover and the inflow portion are connected, and fixing pins that are caught on and fixed to an upper portion of the housing are formed at another ends of the cover and the inflow portion.

9. The vent module of claim 8, wherein the fixing pin formed on the cover is caught on the housing in a state that the vent portion is disposed in the first position, and the fixing pin formed on the inflow portion is caught on the housing in a state that the vent portion is disposed in the second position.

10. The vent module of claim 5, wherein a fastener for fixing the housing door in a closed state is formed on one side of the housing door, and the fastener protrudes by an elastic force applied from an elastic body and is caught on a fastening groove formed in the housing.

11. The vent module of claim 5, wherein the discharge portion is formed to be curved so that the vent portion is formed in a fan shape in a cross section thereof, and the vent portion rotates based on the center of a circle forming the fan shape.

12. The vent module of claim 5, wherein the hose include wrinkles formed at an end connected to the inflow portion of the hose so that the hose is foldable.

13. A vehicle comprising:
a cockpit module; and
the vent module of claim 1, installed on one side of the cockpit module.
